(19) United States
(12) Patent Application Publication
(10) Pub. No.: US 2025/0154874 A1
(43) Pub. Date: May 15, 2025

(54) COMPOSITE VANE FOR AN AIRCRAFT TURBOMACHINE FAN COMPRISING MEANS FOR MEASURING INTERNAL DEFORMATIONS

(71) Applicant: SAFRAN AIRCRAFT ENGINES, Paris (FR)

(72) Inventors: Mattéo MINERVINO, MOISSY-CRAMAYEL (FR); Damien Bruno LAMOUCHE, MOISSY-CRAMAYEL (FR); Julie Valérie Clara LAVIGNE, MOISSY-CRAMAYEL (FR); Tony Alain Roger Joël LHOMMEAU, MOISSY-CRAMAYEL (FR)

(73) Assignee: SAFRAN AIRCRAFT ENGINES, Paris (FR)

(21) Appl. No.: 18/835,676

(22) PCT Filed: Jan. 31, 2023
(86) PCT No.: PCT/FR2023/050123

§ 371 Date: Aug. 2, 2024

(30) Foreign Application Priority Data
Feb. 3, 2022 (FR) FR2200954

(51) Int. Cl. F01D 5/28; B29C 37/00; B29C 70/22; B29C 70/48; B29C 70/68; B29K 105/08; B29K 307/04; B29L 31/08

(52) U.S. Cl. CPC F01D 5/282; B29C 37/00; B29C 70/22; B29C 70/48; B29C 70/681; B29C 2037/90; B29K 2105/0845; B29K 2307/04; B29L 2031/08; F05D 2220/323; F05D 2230/211; F05D 2240/30; F05D 2300/603

(57) ABSTRACT

A blade made of a composite material for an aircraft turbomachine fan, the blade comprising means for measuring internal deformations of the blade and means for remotely storing and transmitting signals for measuring the deformation of the blade, which means are connected to the measuring means, the measuring means and the remote storage and transmission means being located in the composite material. The means for measuring can be configured to supply the means for remotely storing and transmitting.

### TECHNICAL FIELD

The present invention relates to the field of turbomachinery used to propel an aircraft and, more specifically, a blade for an aircraft turbomachine fan.

### PRIOR ART

In a known manner, a turbomachine is designed to provide the necessary thrust to propel an aircraft. It conventionally comprises at least one compressor, a combustion chamber and at least one turbine to rotate the compressor.

Upstream, considering the direction of an airflow entering the turbomachine, the turbomachine has a fan for accelerating the airflow from upstream to downstream in the turbomachine and comprising blades generally extending in a same plane transverse to the axis of the turbomachine.

The blades are generally made of a composite material and constitute parts which have to be periodically inspected by ground maintenance operators.

These inspections can be performed using conventional non-destructive methods, such as visual observation, acoustic or thermal measurement or X-ray tomography.

However, visual observation is limited to detectable faults on the surface of the part.

The disadvantage of these conventional methods is that they take a long time to carry out, and may require several hours of work for a single part. In addition, these methods may require the use of specific equipment and/or are difficult to carry out when the part is mounted on the engine.

### DISCLOSURE OF THE INVENTION

The object of the invention is therefore to overcome this drawback and to propose a blade for an aircraft turbomachine fan which makes it possible to determine the mechanical stresses exerted on the blade during flight so that, if necessary, ground maintenance operators can carry out the appropriate inspections.

According to a first object, the object of the invention is therefore a blade for an aircraft turbomachine fan, said blade being made of a composite material.

This blade has means for measuring internal deformations of the blade and means for remotely storing and transmitting blade deformation measurement signals connected to said measurement means, said measurement means and said remote storage and transmission means being located in the composite material.

According to another feature, the measurement means are designed to measure the deformations along predetermined measurement axes.

In one embodiment, the measurement means comprise piezoelectric elements extending in respective predetermined directions.

In this way, thanks to the use of the means for measuring internal deformations of the blade and means for remotely storing and transmitting deformation measurement signals, it is possible to determine the mechanical stresses exerted on the blade during flight, at the core of the blade, and in a non-intrusive way, i.e. without impacting on the performance of the part and the engine. In addition, as the blade is made of composite material, the measurement means and the remote storage and transmission means can be simply integrated into the blade, be lightweight and self-sufficient in energy, whilst being able to withstand the stresses exerted on the blade in flight, as well as production and repair constraints.

The measurement means are advantageously designed to supply said remote storage and transmission means.

The storage and transmission means advantageously have an RFID transponder.

The storage and transmission means preferably comprise means for processing the signals received from the measurement means, said processing means being designed to compare the maximum voltage values of the measurement signals with threshold values and to determine if the maximum voltage value of the measurement signals is within a range of predetermined voltage levels for a predefined period of time.

The storage and transmission means can advantageously be configured remotely so as to adjust said predetermined voltage levels.

In one embodiment, the composite material comprises woven fibres embedded in a resin.

Another object of the invention is a method for manufacturing a composite blade for an aircraft turbomachine fan, comprising steps of weaving a fibre preform, injecting a resin into the preform and curing the resin injected into the preform.

This method has a step of inserting means for measuring internal deformations of the blade and means for remotely storing and transmitting blade deformation measurement signals connected to said measurement means, said measurement means and said remote storage and transmission means being located in the composite material.

In one embodiment, said measurement means and said storage and transmission means are inserted on the outer surface of the preform before the step of injecting the resin.

Said measurement means and said storage and transmission means can also be inserted before the curing step, during a lamination phase.

Another object of the invention is an aircraft turbomachine, comprising a fan comprising at least one blade as defined above.

### BRIEF DESCRIPTION OF THE DRAWINGS

Other aims, features and advantages of the invention will become apparent upon reading the following description, provided purely as a non-limiting example and with reference to the appended drawings wherein:

FIG. 1 is a schematic representation of a turbomachine in longitudinal section fitted with a fan provided with a blade in accordance with the invention;

FIG. 2 is a schematic profile view of a composite blade showing the integration of the measurement means and storage and transmission means;

FIG. 3 shows the constituent parts of an RFID transponder used to make up the means for storing and transmitting the measurement signals;

FIG. 4 is a perspective view showing an exemplary embodiment of a method for manufacturing a blade in accordance with the invention; and

FIG. 5 shows an alternative way of integrating the measurement means into a blade in accordance with the invention.

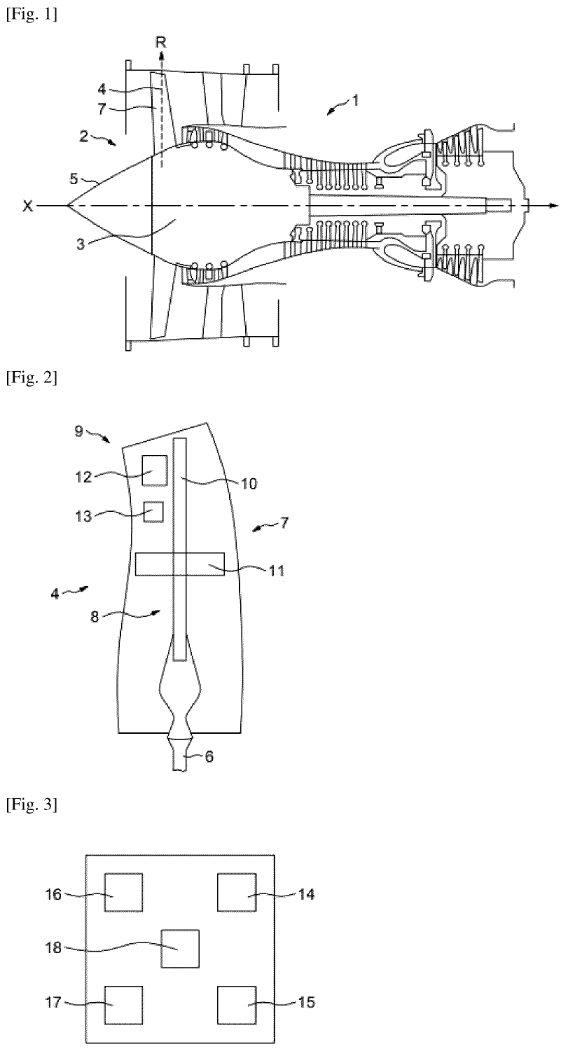

### DETAILED DISCLOSURE OF AT LEAST ONE EMBODIMENT

Reference will first of all be made to FIG. 1, which shows the general architecture of a turbomachine fitted with a fan provided with a blade in accordance with the invention.

As shown, the turbomachine, with general reference number 1, extends along a turbomachine axis X and propels an aircraft from an airflow entering the turbomachine 1 and flowing from upstream to downstream, the terms upstream and downstream being defined in relation to the turbomachine axis X, considering the direction of the air flow in the turbomachine.

In a known manner, the turbomachine 1 comprises a compressor, a combustion chamber and a turbine to rotate the compressor. Upstream, the turbomachine 1 has a fan 2 which accelerates the airflow from upstream to downstream.

The fan 2 comprises a disc 3, rotationally fixed to a shaft of the compressor, comprising housings distributed around the periphery of the disc 3, in which blades 4 are respectively mounted by axial insertion along the turbomachine axis X, from upstream to downstream. The blades extend in a same plane transverse to the turbomachine axis X. In this example, the turbomachine has a cone 5 which is mounted upstream of the disc 3. For the sake of clarity and concision, a single blade 4 will be described from now on. However, the description is applicable to all the blades of the turbomachine.

With reference to FIG. 2 as well, each blade 4 extends along a radial axis R and successively comprises a blade foot 6 designed to be axially mounted along the turbomachine axis X in a housing of the disc 3 of the fan 2 and a blade 7 secured to the blade foot 6 and extending radially along the radial axis R, with respect to the turbomachine axis X.

The blade 4, and more specifically the blade 7, is made of composite material from a fibre preform, by injection of a resin into the preform and curing of the resin injected into the preform.

It incorporates means 8 for measuring internal deformations of the blade and means 9 for remotely storage and transmitting the measurement signals delivered by the measurement means 8.

The means 8 for measuring the internal deformations of the blade are designed to determine the mechanical stresses exerted on the blade during flight, such as deformations and the frequency of excitations, along specific axes.

In one embodiment, these measurement means 8 comprise piezoelectric elements 10 and 11 arranged perpendicular to one another.

For example, a first piezoelectric element 10 extends radially, along the radial axis R of the blade 4, whilst the other piezoelectric element 11 extends perpendicularly, i.e. along the turbomachine axis X.

In the exemplary embodiment shown in FIG. 2, the blade has two piezoelectric elements 10 and 11 respectively arranged radially and axially. Of course, the scope of the invention has not been departed from if the blade has piezoelectric elements extending in other directions or has any number of such elements. However, the blade preferably has piezoelectric elements which are each oriented in a main direction of the stresses exerted on the blade during flight.

It should be noted that the piezoelectric elements must not be too thick so that they can be inserted into the blade. Piezoelectric elements that are between 0.05 mm and 2 mm thick are preferably chosen.

In one embodiment, the blade is produced using a vacuum assisted resin transfer moulding method known as VARTM, by injecting liquid resin into a mould on a fibre preform and then cross-linking the resin. Thus, the material that makes up the piezoelectric element is chosen so as to be able to withstand the temperatures used during VARTM, which can typically reach 250° C.

Similarly, when the blade is produced by vacuum assisted resin transfer from an RTM resin, the material of the piezoelectric elements must be compatible with the material of the RTM composite resin, ideally of the same family or compatible with this matrix. For example, if the matrix is an epoxy base, an epoxy or epoxy-compatible resin is preferred.

However, it should be noted that the composite blade can also be manufactured using other techniques, in particular resin infusion thermo-compression, autoclave or press curing.

Furthermore, the resonance frequency of the piezoelectric elements must be set to a value different from and higher than the resonance frequency of the blade.

Finally, the piezoelectric elements are wire-connected to the means 9 for remotely storing and transmitting deformation measurement signals such that the piezoelectric elements are able to supply the storage and transmission means 9.

The means 9 for storing and transmitting measurement signals deformation have an RFID transponder 12 and 13 for each piezoelectric element 10 and 11.

Each transponder 12 and 13 has a memory 14 for storing the measurement signals from a piezoelectric element 10 or 11, a data processing circuit 15, which measures the signals from the piezoelectric element, in particular by determining the voltage frequency of the measurement signal from the piezoelectric element, the voltage peak and the average voltage, and which performs logic operations on the data extracted from the measurement signals.

Furthermore, each transponder 12 and 13 has an antenna 16 associated with a communication circuit 17 for remote communication with external devices, for example a reader that can be accessed by maintenance operators, as well as a circuit 18 for managing the power supplied by the piezoelectric elements.

It should be noted that the antenna 16 is designed so as to operate in the specific non-conductive material of the area where it is located. Each RFID transponder must also be limited in thickness in order to be inserted into the blade. It is advantageous between 0.05 mm and 2 mm thick.

The communication circuit 17 preferably incorporates a UHF type RFID function, i.e. in a frequency range between 860 MHz and 960 MHz. Such a UHF RFID function enables communication with an external reader using current standard protocols. For example, the memory 14 comprises a capacity of between 512 octets and 62000 octets.

The power management module 18 preferably provides power management by radio frequency induction.

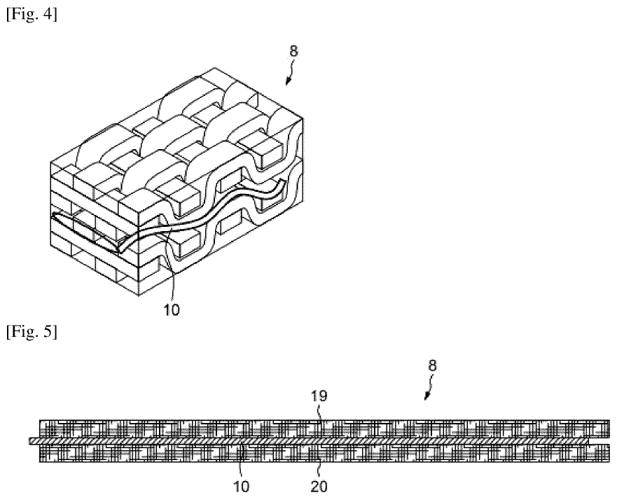

With reference to FIGS. 4 and 5, an exemplary embodiment of a method for manufacturing a blade according to the invention will now be described, integrating means for measuring internal deformations and means for remotely storing and transmitting measurement signals.

As stated above, such a blade is made of composite material from a woven fibre preform, for example from multi-filament carbon strands.

With reference to FIG. 4 first of all, the piezoelectric elements are integrated into the blade during its manufacture, which ensures that the measurement means remain perfectly in place. They can be placed in the core of the composite material or on the surface.

The piezoelectric elements are positioned along the axis whose deformation is to be monitored. As shown in FIG. 4, the piezoelectric elements are integrated during the three-dimensional weaving of the preform (3D composite). Alternatively, as shown in FIG. 5, the piezoelectric elements can be integrated between two plies 19 and 20 of a laminated composite (2D composite).

If the piezoelectric elements are inserted during the three-dimensional weaving of the preform, a debonding area must be provided in order to facilitate the subsequent positioning of the elements required for remotely storing and transmitting the information.

In this way, during the subsequent step, the woven preform is open at the location of the debonding area. The storage and transmission means are then positioned and these means are connected to the deformation measurement means.

These elements are then protected using carbon via two plies of dry glass fibre to isolate the communication circuits from the carbon fibres, thereby increasing the signal detection distance.

In terms of the blades made from laminated composite (FIG. 5), the positioning of the communication circuits is facilitated because it can be carried out during the formation of the composite plies. However, it is also necessary to introduce local protection with a dry glass fabric to isolate the communication circuits from the carbon fibres.

After this step, a resin is injected and then a step involving curing by heat treatment is carried out. It can, for example, involve infusion, autoclave curing or press curing.

As stated above, the data processing circuit 15 on the one hand measures the signals from the piezoelectric elements and, on the other hand, processes the received data.

In operation, if the blade undergoes deformation, or a deformation cycle, the piezoelectric element(s) in question generate a voltage which is supplied to the storage and transmission means 9. This voltage is representative of the deformation experienced by the blade.

The maximum voltage value of the measurement signals represents the amplitude of the mechanical deformation of the blade. The frequency of the voltage represents the mechanical excitation frequency and the average voltage corresponds to the average level of deformation. The maximum voltage value, the average voltage value for a predetermined duration and the excitation frequency are stored in the memory 14.

The information is processed and stored in the memory, for example, according to the following protocol.

If the maximum voltage U is between two minimum and maximum threshold values m and n for a time period t between two minimum and maximum values t1 and t2, the maximum value, the average value over this time period t, the excitation frequency as well as the time of the event are stored.

If the maximum voltage value U is between the two threshold values m and n for a time period t greater than the maximum time period t2, the maximum voltage value, the average voltage value over this time period t, the excitation frequency over this time period t as well as the time of the event are stored in the memory 14. In addition, the transponder in question sends the information via its RFID antenna to advise that an event for which a voltage peak between the minimum m and maximum value n over a time period greater than the maximum threshold value t2 is currently in progress.

Finally, if the maximum voltage is greater than the maximum threshold value n, the maximum voltage value, the average voltage value over the time period of the event and the excitation frequency over the time period of the event are stored. The transponder in question remotely sends the information via its RFID antenna to indicate that an event for which the maximum measurement voltage value U is greater than the maximum threshold value is currently in progress.

It should be noted that the voltage threshold values and the time period threshold values can be remotely configured, the external reader being able to modify the values of these threshold values.

1. A blade for an aircraft turbomachine fan, the blade being made of a composite material, the blade comprising:
means for measuring internal deformations of the blade; and
means for remotely storing and transmitting blade deformation measurement signals connected to means for measuring,
wherein the means for measuring and the means for remotely storing and transmitting are located in the composite material, and wherein the means for measuring is configured to supply the means for remotely storing and transmitting.

2. The blade according to claim 1, wherein the means for measuring is designed to measure the deformations along predetermined measurement axes.

3. The blade according to claim 1, wherein the means for measuring comprises piezoelectric elements extending in respective predetermined directions.

4. (canceled)

5. The blade according to claim 1, wherein the means for remotely storing and transmitting has an RFID transponder.

6. The blade according to claim 1, wherein the means for remotely storing and transmitting comprises means (15) for processing the signals received from the means for measuring, and
wherein the means for processing is configured to compare the maximum voltage values of the measurement signals with threshold values and is configured to determine if the maximum voltage value of the measurement signals is within a range of predetermined voltage levels for a predefined period of time.

7. The blade according to claim 1, wherein the means for remotely storing and transmitting can be configured remotely so as to adjust the predetermined voltage levels.

8. The blade according to claim 1, wherein the composite material comprises woven fibers embedded in a resin.

9. A method for manufacturing a composite blade for an aircraft turbomachine fan, the method comprising:
weaving a fiber preform;
injecting a resin into the preform;
curing the resin injected into the preform; and
inserting, into the composite material, means for measuring internal deformations of the blade and means (9) for remotely storing and transmitting blade deformation measurement signals connected to the means for measuring.

10. The method according to claim 9, wherein the means for measuring and the means for remotely storing and transmitting are inserted on the outer surface of the preform before the step of injecting the resin.

11. The method according to claim 9, wherein the means for measuring and the means for remotely storing and transmitting are inserted during a lamination phase before the step of curing the resin.

12. An aircraft turbomachine comprising a fan having at least one blade according to claim 1.

13. An aircraft comprising an aircraft turbomachine according to claim 12.
